(19) United States
(12) Patent Application Publication
(10) Pub. No.: US 2025/0117252 A1
(43) Pub. Date: Apr. 10, 2025

(54) INSTRUCTION DISPATCH

(71) Applicant: Arm Limited, Cambridge (GB)

(72) Inventors: Kim Richard SCHUTTENBERG, Gilbert, AZ (US); Joshua David KNEBEL, Austin, TX (US)

(21) Appl. No.: 18/483,636

(22) Filed: Oct. 10, 2023

(51) Int. Cl. G06F 9/48; G06F 9/30; G06F 9/38

(52) U.S. Cl. CPC G06F 9/4881; G06F 9/30007; G06F 9/3836

(57) ABSTRACT

Apparatuses, methods, systems, chip containing products, and computer readable media are disclosed. An apparatus comprises dispatch circuitry to receive instructions, and to identify linear chains of instructions each comprising a first instruction and one or more further instructions, which are temporarily ineligible for execution due to a dependence on an immediately preceding instruction. The apparatus further comprises offline storage circuitry. The dispatch circuitry is configured, for each of the linear chains: to dispatch the sequentially first instruction to the issue circuitry and to retain the one or more further instructions in the offline storage circuitry until a chain trigger signal is received, the chain trigger signal indicating that a previously dispatched instruction, on which a sequentially next instruction depends, has satisfied a predefined issuing condition. In response to receipt of the chain trigger signal, the dispatch circuitry is configured to dispatch the sequentially next instruction to the issue circuitry.

### TECHNICAL FIELD

The present invention relates to data processing. More particularly the present invention relates to an apparatus, a system, a chip containing product, a non-transitory computer-readable medium, and a method.

### BACKGROUND

Some processing apparatuses are provided with dispatch circuitry to receive decoded instructions and to dispatch those decoded instructions to issue circuitry for subsequent execution.

### SUMMARY

In a first example configuration there is provided an apparatus comprising:
dispatch circuitry configured to receive a sequence of decoded instructions for dispatch to issue circuitry as dispatched instructions, and to identify linear chains of instructions from the sequence of decoded instructions based on inter-instruction dependencies between the sequence of decoded instructions, wherein each one of the linear chains comprises a sequentially first instruction and one or more further instructions, each of the one or more further instructions being temporarily ineligible for execution due to a dependence on an immediately preceding one of the sequence of instructions comprised in that one of the linear chains; and
offline storage circuitry configured to store the one or more further instructions comprised in a plurality of the linear chains,
wherein the dispatch circuitry is configured, for each linear chain of the linear chains:
to dispatch the sequentially first instruction of the linear chain to the issue circuitry;
to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, to dispatch the sequentially next one of the of the one or more further instructions comprised in the linear chain to the issue circuitry.

In a second example configuration there is provided a system comprising:
the apparatus according to the first example configuration, implemented in at least one packaged chip;
at least one system component; and
a board,
wherein the at least one packaged chip and the at least one system component are assembled on the board.

In a third example configuration there is provided a chip-containing product comprising the system according to the second example configuration assembled on a further board with at least one other product component.

In a fourth example configuration there is provided a non-transitory computer-readable medium to store computer-readable code for fabrication of an apparatus comprising:
dispatch circuitry configured to receive a sequence of decoded instructions for dispatch to issue circuitry as dispatched instructions, and to identify linear chains of instructions from the sequence of decoded instructions based on inter-instruction dependencies between the sequence of decoded instructions, each one of the linear chains comprising a sequentially first instruction and one or more further instructions, each of the one or more further instructions being temporarily ineligible for execution due to a dependence on an immediately preceding one of the sequence of instructions comprised in that one of the linear chains; and
offline storage circuitry configured to store the one or more further instructions comprised in a plurality of the linear chains,
wherein the dispatch circuitry is configured, for each linear chain of the linear chains:
to dispatch the sequentially first instruction of the linear chain to the issue circuitry;
to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, to dispatch the sequentially next one of the of the one or more further instructions comprised in the linear chain to the issue circuitry.

In a further example configuration there is provide a method comprising:
receiving a sequence of decoded instructions for dispatch to issue circuitry as dispatched instructions;
identifying linear chains of instructions from the sequence of decoded instructions based on inter-instruction dependencies between the sequence of decoded instructions, each one of the linear chains comprising a sequentially first instruction and one or more further instructions, each of the one or more further instructions being temporarily ineligible for execution due to a dependence on an immediately preceding one of the sequence of instructions comprised in that one of the linear chains;
for each linear chain of the linear chains:
dispatching the sequentially first instruction of the linear chain to the issue circuitry;
retaining the one or more further instructions of the given linear chain in offline storage circuitry configured to store the one or more further instructions comprised in a plurality of the linear chains until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, dispatching the sequentially next one of the of the one or more further instructions comprised in the linear chain to the issue circuitry.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an example of a set of linear chains according to some configurations of the present techniques;

FIG. 4a schematically illustrates dispatch of instructions according to some configurations of the present techniques;

FIG. 4b schematically illustrates dispatch of instructions according to some configurations of the present techniques;

FIG. 4c schematically illustrates dispatch of instructions according to some configurations of the present techniques;

FIG. 4d schematically illustrates dispatch of instructions according to some configurations of the present techniques;

FIG. 5 schematically illustrates an apparatus according to some configurations of the present techniques;

FIG. 6a schematically illustrates a sequence of steps according to some configurations of the present techniques;

FIG. 6b schematically illustrates a sequence of steps according to some configurations of the present techniques;

FIG. 7 schematically illustrates a sequence of steps according to some configurations of the present techniques;

FIG. 8 schematically illustrates a sequence of steps according to some configurations of the present techniques; and

FIG. 9 schematically illustrates a system and chip-containing product according to some configurations of the present techniques.

### DESCRIPTION OF EXAMPLE CONFIGURATIONS

Before discussing the configurations with reference to the accompanying figures, the following description of configurations is provided.

In some processing apparatuses instructions can be executed out-of-order (i.e., in a different order to the sequential order specified by the compiler/programmer). Such apparatuses may be provided with additional hardware configured to support this type of processing. For example, some processing apparatuses capable of out-of-order execution may be provided with issue circuitry that is arranged to receive decoded instructions and to store those instructions until it is determined that operands required by those operations are available and, when it is determined that this is the case, to issue those instructions to execution units. Because the instructions can be executed out-of-order, the issue circuitry may, at any one time, store numerous instructions that are awaiting execution. The issue circuitry may respond to an indication that an operand is available (for example, as a result of a preceding arithmetic or logical instruction completing, or as a result of a load operation returning the operand) by checking whether the availability of the operand means that any of the stored instructions are ready for execution. As a result, the issue circuitry is constantly polling (checking) each instruction that it stores to determine if that instruction can be issued for execution. This approach requires instruction storage circuitry that is costly both in terms of area and in terms of power consumption.

According to some configurations there is provided an apparatus comprising dispatch circuitry configured to receive a sequence of decoded instructions for dispatch to issue circuitry as dispatched instructions. The dispatch circuitry is configured to identify linear chains of instructions from the sequence of decoded instructions based on inter-instruction dependencies within the sequence of decoded instructions. Each one of the linear chains comprises a sequentially first instruction and one or more further instructions, each of the one or more further instructions being temporarily ineligible for execution due to a dependence on an immediately preceding one of the sequence of instructions comprised in that one of the linear chains. The apparatus is also provided with offline storage circuitry configured to store the one or more further instructions comprised in a plurality of the linear chains. The dispatch circuitry is configured, for each linear chain of the linear chains, to dispatch the sequentially first instruction of the linear chain to the issue circuitry, and to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition. The dispatch circuitry is also configured, in response to receipt of the chain trigger signal, to dispatch the sequentially next one of the one or more further instructions comprised in the linear chain to the issue circuitry.

The inventors have recognised that there are some common use cases in which instructions may be sent to issue long before they are eligible for execution. For example, where any two instructions have a producer-consumer relationship, the consumer instruction is ineligible for execution until the producer instruction has been executed. The storage of both the producer instruction and the consumer instruction in the issue circuitry therefore results in wasted power and requires the issue storage to be sufficiently large to store both the instruction that is potentially eligible for execution (i.e, the producer instruction) and the instruction that is currently ineligible for execution (i.e., the consumer instruction). The apparatus is therefore provided with dispatch circuitry that is configured to receive a sequence of instructions and, dependent on inter-instruction dependencies, is configured to identify such producer-consumer relationships in the form of linear chains of instructions and temporarily to retain the consumer instructions in offline storage circuitry.

For a sequence of instructions, the dependencies between instructions can be represented by a directed graph with nodes representing instructions and edges representing dependencies between instructions. In general, a directed graph is not in the form of a single linear chain of instructions. Instead, the directed graph may comprise branch points (for example, where multiple instructions are dependent on a single preceding instruction) and convergence points (for example, where one instruction is dependent on multiple preceding instructions). Rather than tracking every dependency present in such a directed graph, the dispatch circuitry is configured to simplify the dependencies into plural linear chains of instructions, where each instruction in a linear chain is dependent on an immediately preceding instruction. The linear chains therefore do not track every dependency of every instruction. Instead, branches in the dependencies and convergences in the dependencies are not tracked as a single linear chain but may instead be represented as a plurality of linear chains. For example, where a branch point in the dependencies is detected (two instructions dependent on a result of a single preceding instruction), one of those instructions may be included in a linear chain with the single preceding instruction whilst another of those instructions may form a first instruction of a new linear chain.

The sequentially first instruction of each linear chain is an instruction that may be eligible for execution or that may be dependent on another instruction in a manner that is not tracked as part of the plurality of linear chains. The one or more further instructions in each linear chain are instructions that are temporarily ineligible for execution due to their dependency on the immediately preceding instruction in the linear chain. The dispatch circuitry is therefore configured to dispatch the sequentially first instruction of each linear chain to the issue circuitry where the issue circuitry will store the instruction and determine whether or not it is actually eligible for execution, i.e., whether the operands required by that instruction are available. The one or more further instructions of each linear chain cannot be executed until the instruction preceding them in the linear chain has been executed and are therefore stored in an offline storage structure. Instructions in the offline storage structure need not be checked for execution because it has already been determined that they are temporarily ineligible and, hence, can make use of lower power and more compact storage circuitry allowing for a reduced amount of storage to be provided as part of the issue circuitry resulting in savings in both power and circuit area. The dispatch circuitry is configured to monitor the issue circuitry for chain trigger signals identifying that an instruction from one of the linear chains has been issued for execution and, in response to the chain trigger signal, to dispatch the sequentially next one of the one or more further instructions comprised in the identified linear chain.

By considering only linear chains, the analysis performed by the dispatch circuitry is relatively simple, allowing for an efficient implementation that results in a reduced requirement for storage in the issue circuitry without requiring complex analysis circuitry to be provided at the dispatch stage. Furthermore, because the chains are linear, the manner in which the one or more further instructions are stored in the offline storage circuitry is simplified as it is known, for each linear chain, which instruction is the next instruction that is to be dispatched to the issue circuitry.

The dispatch circuitry, the issue circuitry and the offline storage circuitry may be provided as discrete blocks of circuitry or may be combined into one or more blocks of circuitry that together perform the functions described above. For example, the offline storage circuitry may be provided within the dispatch circuitry or may be provided as a separate bank of storage that is accessible to the dispatch circuitry.

In some configurations the issue circuitry is responsive to receipt of a dispatched instruction: in response to a determination that one or more operands associated with the dispatched instruction are indicated as ready, to mark the dispatched instruction as ready for execution; and in response to a determination that the one or more operands associated with the dispatched instruction are not indicated as ready, to store the dispatched instruction in an issue queue. The issue queue may be a single issue queue or one of a plurality of possible issue queues. The dispatched instructions that are marked as ready for execution may be issued on a next issue cycle or may be stored in an issue queue (for example, if a greater number of instructions are marked as ready for execution than the number of available processing pipelines). The instructions may be marked as ready in any manner. For example, each instruction may be stored in association with one or more bits each indicative of one of the operands associated with that instruction. The bit may be set to a first value to indicate that the operand is ready and to a second value to indicate that the operand is not ready. An instruction may be determined as being marked as ready when each of the bits associated with that instruction indicates that the corresponding operand is available.

In some configurations the issue circuitry is responsive to broadcast information indicating readiness of an operand: to store an indication of readiness of the operand in an operand availability table; to determine, for each dispatched instruction stored in the issue queue and not marked as ready for execution, whether the operand corresponds to the one or more operands associated with that dispatched instruction; and when the operand corresponds to one of the one or more operands associated with that dispatched instruction, to tag that dispatched instruction with information indicating the availability of the operand. The broadcast information may be provided by one or more circuitry elements further down an execution pipeline. For example, the broadcast information could be provided once a result of an issued instruction is available during execution of that instruction or at a subsequent stage of the pipeline (e.g., a commit stage). The broadcast information is compared to each instruction that is stored in the issue circuitry, to determine if the operand is required by those instructions, and is stored in the operand availability table such that it can subsequently be compared against dispatched instructions that are received by the issue circuitry subsequent to the receipt of the broadcast information.

In some configurations the issue circuitry is responsive to a determination that each of the one or more operands associated with one of the dispatched instructions is indicated as available, to mark that dispatched instruction as ready for execution. The instruction may then be issued for execution or may continue to be stored in an issue queue for subsequent execution (for example, if a greater number of instructions are marked as ready for execution than the number of available processing pipelines).

In some configurations the issue circuitry is configured, when determining whether to mark dispatched instructions as ready for execution, to: consider the dispatched instructions stored in the issue queue; and defer considering the one or more further instructions retained in the offline storage circuitry until those instructions are dispatched to the issue queue. The broadcast information is therefore not passed to the offline storage circuitry and the offline storage circuitry is not provided with logic suitable for interpreting the broadcast information. The offline storage circuitry can therefore be arranged, for example, as a first in first out queue in which only instructions that are at the head of the queue can be dispatched to the issue circuitry. This further reduces the complexity of the offline storage circuitry.

The predetermined issuing condition may take a variety of forms. In some configurations the predefined issuing condition is satisfied when a dispatched instruction comprised in the linear chain is issued for execution. When the dispatched instruction comprised in the linear chain is issued for execution, the sequentially next instruction in that linear chain may become eligible for issue on the next cycle. The issue circuitry therefore issues the chain trigger signal identifying the linear chain to trigger the dispatch circuitry to dispatch the sequentially next one of the one or more further instructions comprised in the linear chain to the issue circuitry. The chain trigger signal may be provided in a variety of ways. For example, the chain trigger signal could be provided with a dedicated line per linear chain with the value of the dedicated line being pulled high (or low) when the trigger signal is issued. Alternatively, the chain trigger signal could be transmitted as a chain identifier bit stream over a dedicated transmission channel with multiple chain identifiers being sent sequentially.

In some configurations for at least a predefined type of dispatched instruction, the predefined issuing condition is considered to be speculatively satisfied when the predefined type of dispatched instruction is marked as ready for execution. The process of marking the instructions as ready for execution may be conducted in a separate instruction cycle to the selection of ready instructions to be issued for execution. Therefore, at the time that an instruction is marked as being ready for execution it may not be known whether that instruction will be issued for execution or will be retained in the issue queue pending availability of a specific processing pipeline. Rather than waiting for the instructions to issue, it may be beneficial speculatively to transmit the chain trigger signal to ensure that the next instruction in the linear chain is dispatched to the issue circuitry sooner. For example, in some configurations the predefined type of dispatched instruction may be a low latency instruction.

In some configurations the predefined type of dispatched instruction is a single cycle latency instruction. Where the chain trigger signal is only transmitted at the point where an instruction is issued for execution, there is a possibility that additional latency could be incurred if the sequentially next instruction is not available in the issue queue at a time at which the instruction broadcasts availability of its results. Therefore, by speculatively transmitting the trigger signal for single cycle latency instructions, the overall latency may be reduced. A single cycle latency instruction may be identified in a variety of ways. In some configurations, the issue circuitry identifies single cycle latency instructions, for example, based on an opcode identifying the instruction. In other configurations, the single cycle latency instruction may be identified at the dispatch stage and may be dispatched along with a tag indicating that the instruction is a single cycle latency instruction. The issue circuitry is therefore able to determine whether or not the instruction is a single cycle latency instruction by reading the tag.

In some configurations the dispatch circuitry is configured to, when the sequentially next further instruction is dispatched and when the sequentially next further instruction is dependent only on the previously dispatched instruction, mark the sequentially next further instruction as ready for execution. Marking the sequentially next further instruction as ready for execution prior to any determination by the issue circuitry may reduce latency associated with the issuing of that instruction. In particular, the dispatch circuitry may mark each instruction stored in the offline storage circuitry to indicate whether it is a dependent only on the previously dispatched instruction such that, when that instruction is dispatched, it can be marked as ready for execution without having to check the availability of operands in the operand availability table resulting in reduced latency and reduced power consumption.

During program execution the apparatus may be responsive interrupts or exceptions that require the processing pipeline to be flushed. In some configurations the offline storage circuitry is responsive to a flush request, to discard the one or more further instructions comprised in each of the linear chains. Discarding the instructions may involve clearing the offline storage circuitry or marking each instruction in the offline storage circuitry as invalid. In some configurations the offline storage circuitry may be responsive to the flush request in response to a context switch to store the one or more further instructions to stack storage prior to discarding the instructions and may restore the one or more further instructions in response to a context return.

The process by which the linear chains are identified may be variously defined. In some configurations the dispatch circuitry is configured to identify instructions belonging to each linear chain of instructions by assigning a chain identifier from a pool of chain identifiers to those instructions; and the dispatch circuitry is configured, for each decoded instruction of the sequence of decoded instructions: to determine whether the decoded instruction is dependent on one or more active linear chains of instructions; and when the decoded instruction is dependent on one or more active linear chains, to assign, to the decoded instruction, the chain identifier assigned to one of the one or more active linear chains on which the decoded instruction depends. The size of the pool of chain identifiers may be dependent on the implementation. For example, in larger out-out-of-order processors a greater number of chain identifiers may be provided compared to a smaller out-of-order processor. In some configurations 8, 16, or 32 chain identifiers may be provided. Each chain identifier may be stored in association with an indication as to whether that chain identifier is an active chain identifier and an indication of the result operand produced as a result of the sequentially last instruction currently comprised in the linear chain. The dispatch circuitry can then determine for each received decoded instruction whether an operand required by that decoded instruction is one of the results produced by a sequentially last instruction currently comprised in a linear chain and, if so, can assign the dispatched instruction to that linear chain.

As discussed, each decoded instruction may be dependent on multiple previous instructions (for example, through multiple operands that are each produced by a different preceding instruction). In some configurations the dispatch circuitry is configured, when the decoded instruction is dependent on one or more active linear chains, to select the chain identifier assigned to a youngest one of the one or more active linear chains on which the decoded instruction depends. Where an instruction is dependent on two active linear chains, that instruction cannot be issued for execution until the instructions in both of those linear chains have been executed and their results are available as operands for the instruction. As the current techniques track only one of the instruction dependencies, the instruction can only be assigned to one of the two linear chains. By assigning the instruction to the youngest one of the active linear chains on which the decoded instruction depends, the likelihood that the instruction will be dispatched for execution before the preceding instructions have executed is reduced resulting in a reduced number of instructions being stored in the issue queues.

In some configurations the dispatch circuitry is configured, when the decoded instruction is not dependent on any active linear chains and when at least one further decoded instruction is dependent on the decoded instruction, to perform a chain identifier assignment procedure comprising: when the pool of chain identifiers comprises an unassigned chain identifier, assigning the unassigned chain identifier to the decoded instruction; and when the pool of chain identifiers comprises no unassigned chain identifiers, to dispatch the decoded instruction to the issue circuitry without assigning a chain identifier. The dispatch circuitry therefore identifies a minimum chain length of two instructions (although the linear chains could potentially be longer). Even linear chains of two instructions will result in a reduction in the storage requirements provided by the issue circuitry resulting in savings in circuit area and power. When each of the chain identifiers in the pool of chain identifiers is assigned, and the dispatch circuitry receives an instruction that cannot be added to an existing active linear chain, the dispatch circuitry dispatches the instruction to issue circuitry without assigning the instruction to a linear chain. As a result, when there are no available linear chain identifiers, the dispatch circuitry defaults to using the mechanisms present as part of the issue circuitry to determine whether or not the instructions are available for execution.

In some configurations the dispatch circuitry is configured, when the decoded instruction is not dependent on any active linear chains and when at no further decoded instructions are identified as being dependent on the decoded instruction, to dispatch the decoded instruction to the issue circuitry without assigning a chain identifier. The determination as to when to issue such instructions for execution is therefore deferred entirely to the issue circuitry without those instructions being stored in the offline storage circuitry. In other words, instructions that do not form part of a linear chain bypass the offline storage circuitry and rely on the issue circuitry to determine availability of their operands.

The offline storage circuitry may be provided in various forms. In some configurations the dispatch circuitry is configured to store the one or more further instructions of each linear chain as a linked list within the offline storage circuitry. For example, the offline storage circuitry may be provided, for each chain identifier, with a chain head pointer and a chain tail pointer. The chain head pointer points to the sequentially next instruction that is to be dispatched from that linear chain in response to a chain trigger signal indicating that linear chain. Each instruction is stored in association with a pointer to a next instruction comprised in that linear chain and, on dispatch of the instruction from the offline storage circuitry, the head pointer associated with that linear chain is updated to the pointer stored in association with the dispatched instruction. The tail pointer indicates the end of the linear chain and is updated to point to the sequentially final item stored in the linear chain. If, during execution, the head pointer matches the tail pointer, then it can be determined that there are no further instructions in that linear chain and the chain identifier can be marked as inactive. The instructions may also be stored in association with a valid bit indicating whether that storage location contains a stored instruction or whether that storage location can be used to store a new instruction. The validity bits associated with each storage location may be stored in a same storage structure as the instructions or in a separate validity table stored in association with the offline storage. Using a linked list provides flexibility in terms of the maximum length of the linear chains and may provide a more efficient use of storage.

In some configurations the offline storage circuitry is arranged as a plurality of discrete queues and the dispatch circuitry is configured to store the one or more further instructions of each linear chain in one of the discrete queues. Each of the discrete queues may be a first in first out queue and will be of a fixed length. The use of first in first out structures provides a particularly simple implementation and ensures that there is always sufficient space in the offline storage circuitry to utilise all of the linear chains.

Using a plurality of discrete queues places a limitation on the maximum number of instructions that can be stored in each of the linear queues. In some configurations the dispatch circuitry is responsive to a determination that retaining one or more further instructions of one or the linear chains in the offline storage circuitry would cause a capacity of one of the plurality of discrete queues to be exceeded, to split that linear chain into a plurality of linear chains. For example, if the offline storage circuitry were provided with storage for N instructions in each linear chain and the dispatch circuitry identified greater than N instructions in a chain, then the first N instruction can be comprised in a first linear chain and the (N+1)^{th} instruction forms a sequentially first instruction of a second linear chain.

Particular configurations will now be described with reference to the figures.

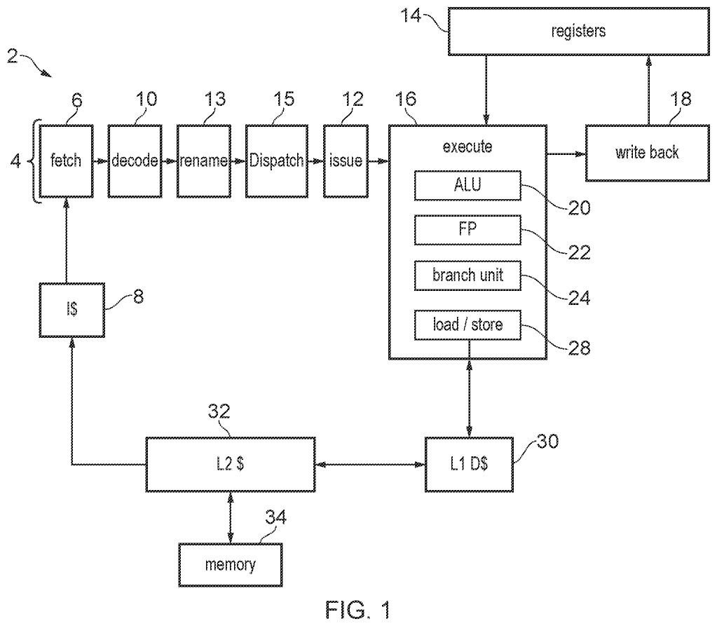

FIG. 1 schematically illustrates an example of a data processing apparatus 2. The data processing apparatus has a processing pipeline 4, which includes a number of pipeline stages. In this example, the pipeline stages include a fetch stage 6 for fetching instructions from an instruction cache 8; a decode stage 10 for decoding the fetched program instructions to generate decoded instructions to be processed by remaining stages of the pipeline; a rename stage 13 to maintain a speculative mapping between a set of architecturally defined registers and a plurality of physical registers 14, and to maintain register commit information identifying which of the plurality of physical registers are protected against reallocation to a different architecturally defined register; a dispatch stage 15 for dispatching instructions to one or more issue queues, an issue stage 12 for checking whether operands required for the micro-operations are available in the register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

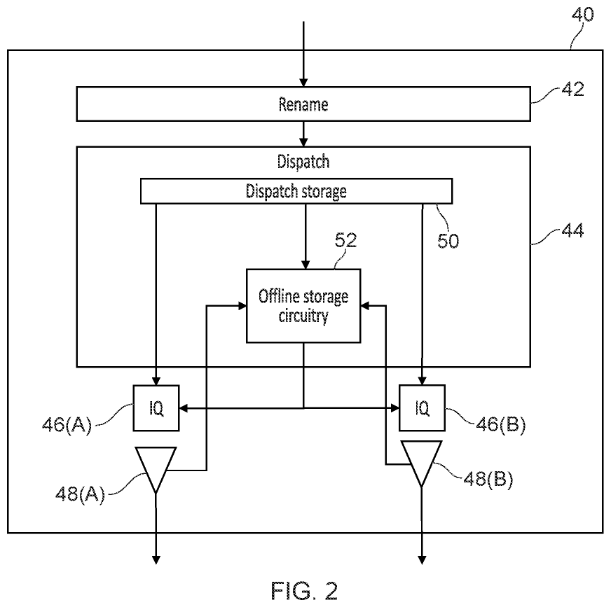

FIG. 2 schematically illustrates further details of an apparatus 40 according to some configurations of the present techniques. The apparatus is provided with rename circuitry 42, dispatch circuitry 44, issue queues 46 and selection circuitry 48. The dispatch circuitry 44 comprises dispatch storage 50 arranged to store decoded instructions pending their assignment to a linear chain and offline storage circuitry 52 arranged to store the one or more further instructions whilst they are deemed to be ineligible for execution. The offline storage circuitry 52 is less costly storage circuitry than the storage provided as part of the issue queues 46. In particular, the offline storage circuitry does not require additional circuitry to enable the selection circuitry 48 to determine whether operands associated with the instructions are available and, hence, whether those instructions are eligible for execution and in some configurations may also be arranged as a first in first out structure.

In operation, the rename circuitry 42 receives decoded instructions from a decoder stage and maintains a mapping between architectural registers referred to in the decoded instructions and physical registers provided as part of the micro-architecture. The decoded instructions are then passed from the rename circuitry 42 to the dispatch circuitry 44 where they may be temporarily stored in the dispatch storage 50 pending dispatch to one of the issue queues 46 or storage in the offline storage circuitry 52. The dispatch circuitry 44 analyses dependencies between the decoded instructions in order to identify linear chains of instructions. Each identified linear chain comprises a sequentially first instruction and one or more further instructions where each of the one or more further instructions is dependent on the immediately preceding instruction in the linear chain. The dispatch circuitry then dispatches the sequentially first instruction to one of the issue queues 46 (bypassing the offline storage circuitry 52) and stores the one or more further instructions in the offline storage circuitry 52. The dispatch circuitry 44 is responsive to identification of a decoded instruction that does not form part of a linear chain (for example, due to all linear chain identifiers already being used, or the instruction having no dependency on other instructions) to dispatch the identified decoded instruction to one of the issue queues 46 without storing that instruction in the offline storage circuitry 52 (bypassing the offline storage circuitry 52).

The issue queues 46, which comprise a first issue queue 46(A) and a second issue queue 46(B), each receive dispatched instructions from the dispatch circuitry 44. The dispatched instructions are stored in the issue queues 46 until they are marked as being eligible for execution. The selection circuitry 48 includes first selection circuitry 48(A) configured to select instructions from the first issue queue 46(A) for execution, and second selection circuitry 48(B) configured to select instructions from the second issue queue 46(B) for execution. The selection circuits 48 are arranged to select the instructions for execution from the group of instructions stored in the corresponding issue queue 46 that are marked as being ready for execution (eligible for execution) due to a determination that each of the operands required for that instruction are available. When an instruction is selected from one of the issue queues 46, the selection circuitry 48 is configured to determine whether or not that instruction is comprised in one of the linear chains and, if so, to transmit a trigger signal to the dispatch circuitry 44 to trigger the sequentially next instruction comprised in that linear chain to be dispatched to the issue queue 46.

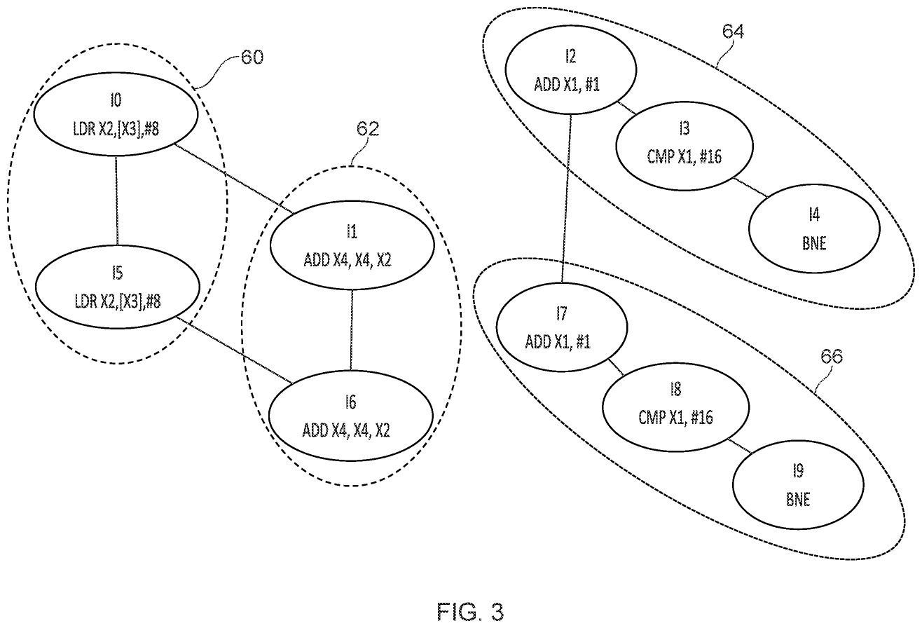

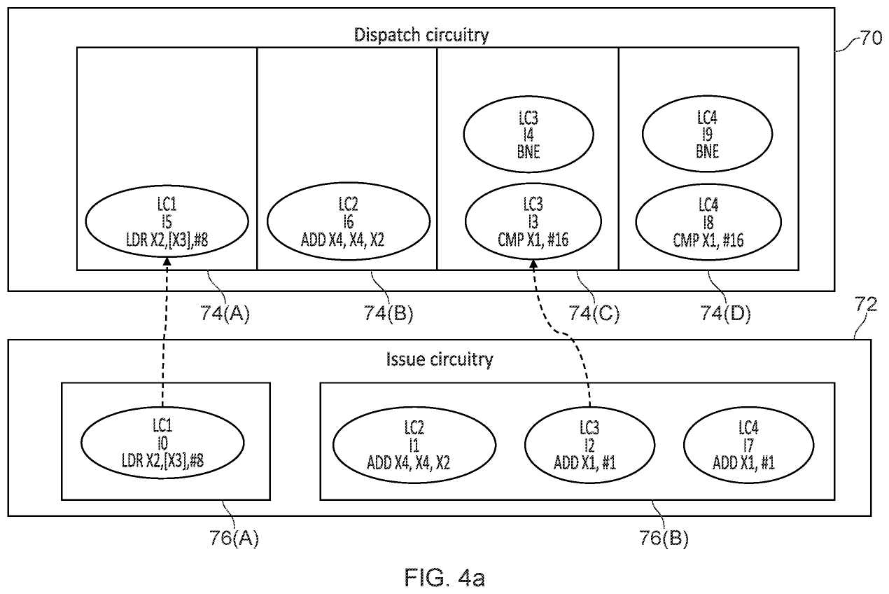

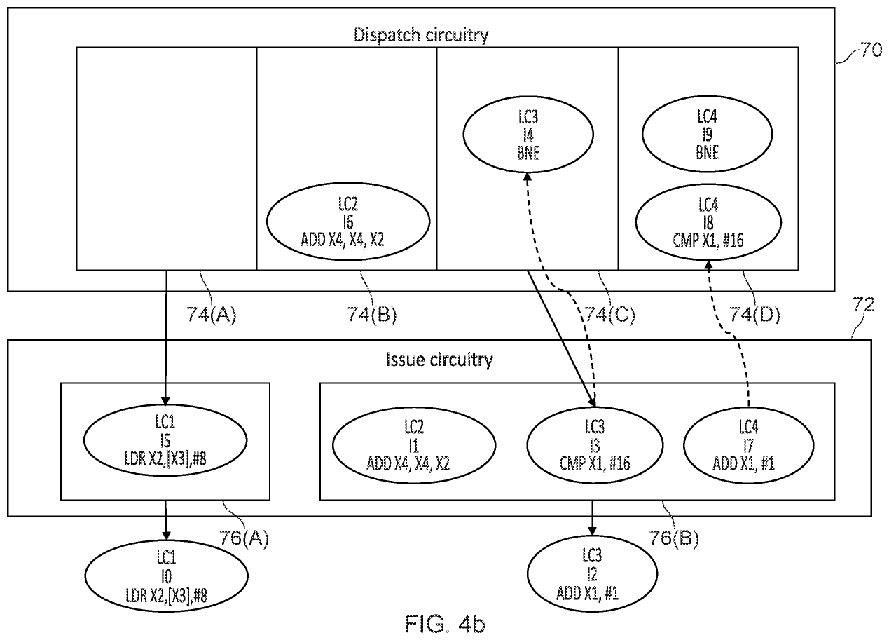

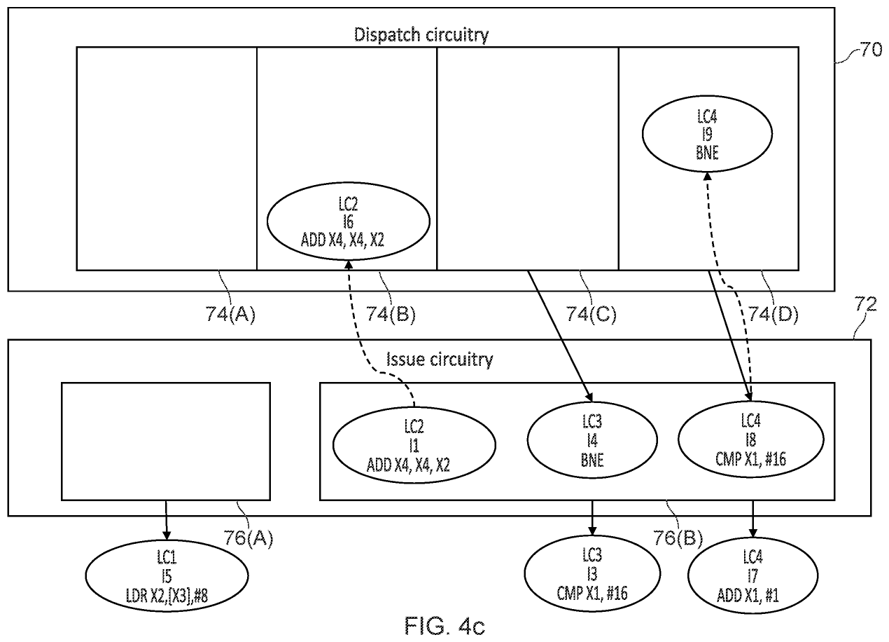

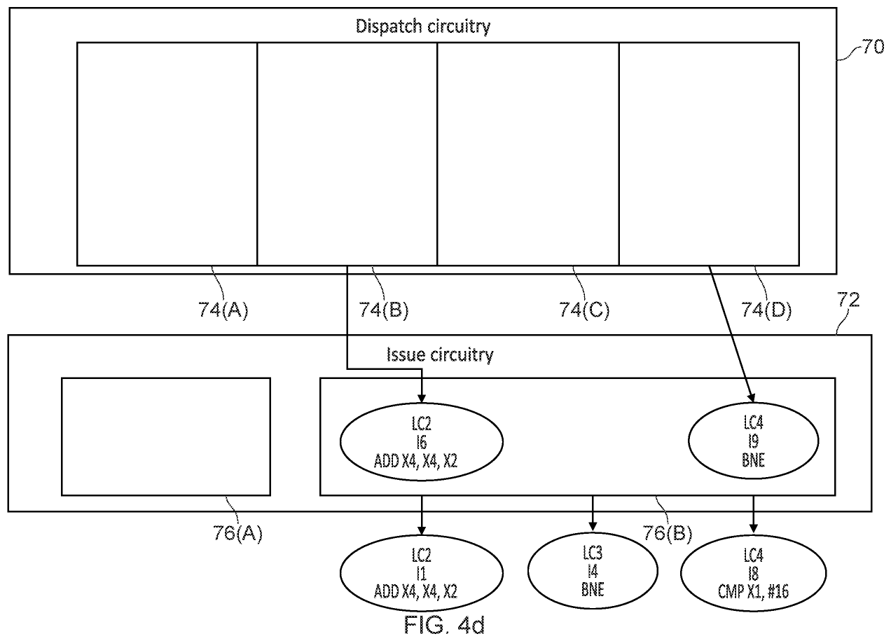

FIGS. 3 and 4a-4d schematically illustrate the grouping of a set of instructions into a plurality of linear chains and the dispatching of those instructions to issue queues and then subsequently to execution circuitry. The following example sequence of instructions is considered in relation to FIGS. 3 and 4a-4d.
I0: LDR X2,[X3],#8
I1: ADD X4, X4, X2
I2: ADD X1, #1
I3: CMP X1, #16
I4: BNE
I5: LDR X2,[X3],#8
I6: ADD X4, X4, X2
I7: ADD X1, #1
I8: CMP X1, #16
I9: BNE

The instructions are numbered I0 to I9 and comprise a repeated sequence of 5 instructions. Instruction I0 is a post-indexed load instruction, which loads a value from location X3 into register X2 and, subsequently updates the value of X3 by adding an 8 byte offset. Instruction I1 adds the value of X2 to X4 and stores the result in X4. Instruction I2 adds 1 byte to the value of X1 and stores the value in X1. Instruction I3 compares the value of X1 to 16 bytes and sets the condition flag when those two values are equal. Instruction I4 is a branch not equal instruction, which branches if the condition flag is not set. These steps are repeated in instructions I5 to I9.

The dependencies between the instructions are illustrated in FIG. 3. Each of the 10 instructions is illustrated as an oval labelled with the instruction number (I0 to I9) and dependences between the instructions are illustrated by solid lines connecting the instructions. As can be seen, instruction I0 is not dependent on any other instructions. Instruction I1 is dependent on instruction I0. Instruction I5 is dependent on instruction I0. Instruction I6 is dependent on both of instruction I1 and instruction I5. Instruction I2 is not dependent on any other instructions. Instruction I3 is dependent on instruction I2 and instruction I4 is dependent on instruction I3. Instruction I7 is dependent on instruction I2. Instruction I8 is dependent on instruction I7. Instruction I9 is dependent on instruction I8.

The instructions are grouped into linear chains, which are illustrated using dashed lines. A first linear chain 60 comprises instructions I0 and I5. Instruction I0 is the sequentially first instruction of the first linear chain 60, and instruction I5 is a further instruction of the first linear chain 60. A second linear chain 62 comprises instructions I1 and I6. Instruction I1 is the sequentially first instruction of the second linear chain 62, and instruction I6 is a further instruction of the second linear chain 62. A third linear chain 64 comprises instructions I2, I3, and I4. Instruction I2 is the sequentially first instruction of the third linear chain 64, and instructions I3 and I4 are further instructions of the third linear chain 64. A fourth linear chain 66 comprises instructions I7, I8, and I9. I7 is a sequentially first instruction of the fourth linear chain 66, and instructions I8 and I9 are further instructions of the fourth linear chain 66. It would be readily apparent to the skilled person that alternative linear chains could be identified from the above sequence of instructions and that any appropriate algorithm for identifying and selecting linear chains could be applied to assign instructions to different linear chains.

FIGS. 4a to 4d schematically illustrate the storage of the instructions identified as part of the linear chains in offline storage circuitry 74 comprised within dispatch circuitry 72 and the dispatch of those instructions to issue queues 76 in issue circuitry 72. The offline storage circuitry 74 is arranged as 4 distinct first in first out (FIFO) structures for storing the linear chains including a first FIFO 74(A) storing linear chain LC1, a second FIFO 74(B) storing linear chain LC2, a third FIFO 74(C) storing linear chain LC3, and a fourth FIFO 74(D) storing linear chain LC4. The issue circuitry is provided with two issue queues 76 including a first issue queue 76(A) and a second issue queue 76(B). In the illustrated configuration the first issue queue 76(A) is arranged to hold data access instructions (e.g., load instructions or store instructions) for issue to a load/store unit and the second issue queue is arranged to hold non-data access instructions (e.g., arithmetic, logical or flow control instructions). In the illustrated configuration the instructions are assigned to the FIFO structures 74 within the dispatch circuitry 70 and are dispatched to the issue queues 76 within the issue circuitry 72. Each instruction is illustrated as an oval and is labelled with both the instruction number and the linear chain identifier.

FIG. 4a schematically illustrates the initial storage of the instructions I0 to I9 in the offline storage circuitry 74 and the issue queues 76. The sequentially first instruction from the first linear chain LC1 is dispatched to the issue circuitry 72 and is stored in the first issue queue 76(A). The further instructions of the first linear chain LC1 are stored in the first FIFO 74(A). The sequentially first instruction from the second linear chain LC2 is dispatched to the issue circuitry 72 and is stored in the second issue queue 76(B). The further instructions of the second linear chain LC2 are stored in the second FIFO 74(B). The sequentially first instruction from the third linear chain LC3 is dispatched to the issue circuitry 72 and is stored in the second issue queue 76(B). The further instructions of the third linear chain LC3 are stored in the third FIFO 74(C). The sequentially first instruction from the fourth linear chain LC4 is dispatched to the issue circuitry 72 and is stored in the second issue queue 76(B). The further instructions of the fourth linear chain LC4 are stored in the fourth FIFO 74(D). In the illustrated configuration it is assumed that the operands required for instructions I0 and I2 are available and, as a result, the issue circuitry 72 is arranged to transmit a trigger signal (illustrated as dashed lines) to the dispatch circuitry 70 indicating the sequentially next instruction in the first linear chain LC1 and the sequentially next instruction in the third linear chain LC3 can be dispatched to the issue circuitry 72.

FIG. 4b schematically illustrates the storage of instructions one cycle later. Instructions I0 and I2 are issued by issue circuitry 72 for execution. The dispatch circuitry 70 responds to the trigger signals transmitted in relation to the first linear chain LC1 and dispatches the sequentially next instruction (I5) of the first linear chain LC1 to the first issue queue 76(A) of the issue circuitry 72. The dispatch circuitry 70 also responds to the trigger signals issued in relation to the third linear chain LC3 and dispatches the sequentially next instruction (I3) of the third linear chain LC3 to the second issue queue 76(B) of the issue circuitry 72. In this cycle it is determined that the operands required for instruction I5 in the first linear chain LC1, the operands required for instruction I3 in the third linear chain LC3 and the operands required for instruction I7 in the fourth linear chain LC4 are available. As a result, the issue circuitry 72 is arranged to transmit a trigger signal (illustrated as dashed lines) to the dispatch circuitry 70 indicating the sequentially next instruction in the third linear chain LC3 and the sequentially next instruction in the fourth linear chain LC4 can be dispatched to the issue circuitry 72. As the instruction I5 is the final instruction in the first linear chain LC1, no trigger signal is issued in relation to that linear chain.

FIG. 4c schematically illustrates the storage of instructions one cycle later. Instructions I5, I3 and I7 are issued by issue circuitry 72 for execution. The dispatch circuitry 70 responds to the trigger signal transmitted in relation to the third linear chain LC3 and dispatches the sequentially next instruction (I4) of the third linear chain LC3 to the second issue queue 76(B) of the issue circuitry 72. The dispatch circuitry 70 also responds to the trigger signal issued in relation to the fourth linear chain LC4 and dispatches the sequentially next instruction (I8) of the fourth linear chain LC4 to the second issue queue 76(B) of the issue circuitry 72. In this cycle it is determined that the operands required for instruction I1 in the second linear chain LC2, the operands required for instruction I4 in the third linear chain LC3 and the operands required for instruction I8 in the fourth linear chain LC4 are available. As a result, the issue circuitry 72 is arranged to transmit a trigger signal (illustrated as dashed lines) to the dispatch circuitry 70 indicating the sequentially next instruction in the second linear chain LC4 and the sequentially next instruction in the fourth linear chain LC4 can be dispatched to the issue circuitry 72. As the instruction I4 is the final instruction in the third linear chain LC3, no trigger signal is issued in relation to that linear chain.

FIG. 4d schematically illustrates the storage of instructions one cycle later. Instructions I1, I4 and I8 are issued by issue circuitry 72 for execution. The dispatch circuitry 70 responds to the trigger signal transmitted in relation to the second linear chain LC2 and dispatches the sequentially next instruction (I6) of the second linear chain LC2 to the second issue queue 76(B) of the issue circuitry 72. The dispatch circuitry 70 also responds to the trigger signal issued in relation to the fourth linear chain LC4 and dispatches the sequentially next instruction (I9) of the fourth linear chain LC4 to the second issue queue 76(B) of the issue circuitry 72. In this cycle it is determined that the operands required for instruction I6 in the second linear chain LC2, and the operands required for instruction I9 in the fourth linear chain LC4 are available. As these instructions are the final instructions in the second and fourth linear chains LC2, LC4, no trigger signal is issued in relation to those linear chains.

It would be readily apparent to the skilled person that in some alternative configurations a trigger signal may be issued in relation to linear chains at a point when the final instruction is issued for execution and that trigger signal may be discarded by the dispatch circuitry 70 on determination that there are no further instructions in those linear chains.

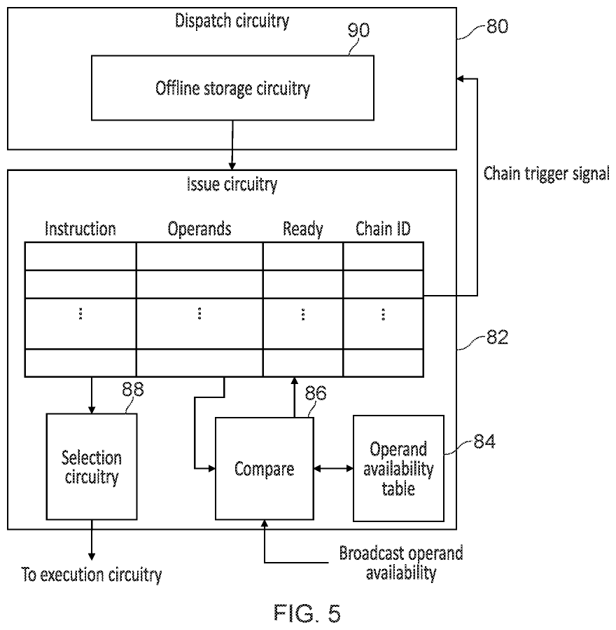

FIG. 5 schematically illustrates further details of the interaction between the issue circuitry 82 and the dispatch circuitry 80 in accordance with some configurations of the present techniques. The issue circuitry 82 is provided with selection circuitry 88, comparison circuitry 86 and an operand availability table 84. The selection circuitry 88 is configured to select instructions to be passed to execution circuitry when those instructions are marked as ready.

The issue circuitry comprises an issue queue storing a set of instructions, operands, an indication as to whether the instruction is ready for execution and a chain identifier indicative of a linear chain to which that instruction belongs. On receipt of a dispatched instruction from the dispatch circuitry 80 (either an instruction that has been previously stored in the offline storage circuitry 90 or an instruction that has bypassed the offline storage circuitry 90), the issue circuitry compare operands identified by that instructions to operands listed in the operand availability table 84. Where the operands associated with the instruction are listed in the operand availability table, the instruction is marked as ready for execution and is recorded in the issue queue so that it may be selected for execution at a next available opportunity. When at least one of the operands that is associated with the instruction is not listed as available in the operand availability table 84, the instruction is listed in the issue queue but is not marked as being ready for execution. When an instruction listed in the issue queue and identifying a chain identifier is marked as ready for execution, a chain trigger signal indicating that chain identifier is passed to the dispatch circuitry 80 to trigger a sequentially next instruction stored in the offline storage circuitry 90 to be dispatched to the issue circuitry.

The issue circuitry 82 is responsive to broadcast information indicating an operand availability to record that operand as being available in the operand availability table 84 and to perform a comparison between each instruction listed in the issue queue and the operands that are now listed as available in the operand availability table 84. Where an instruction is found for which all the operands are listed as available in the operand availability table 84, the comparison circuitry 86 is configured to mark those instructions as ready for execution. The operands may be identified in a variety of ways. In some configurations the operands are identified through physical register identifiers corresponding to physical registers that store those operands. An indication of the physical registers that are available may be retained in the operand availability table from a point at which the operand availability is broadcast to a point at which the physical register is released to a pool of available physical registers.

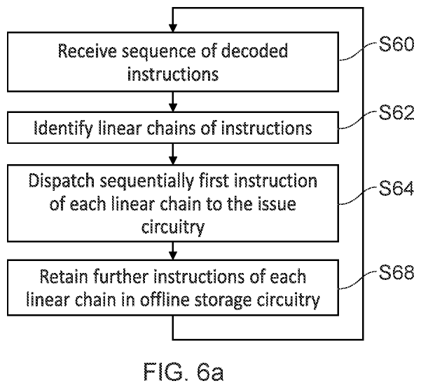

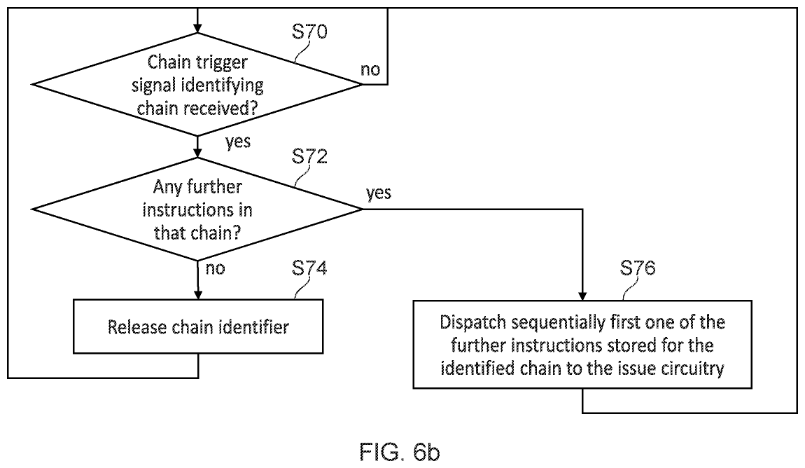

FIG. 6a schematically illustrates a sequence of steps carried out by dispatch circuitry according to some configurations of the present techniques. Flow begins at step S60 where a sequence of decoded instructions is received. Flow then proceeds to step S62 where the dispatch circuitry identifies linear chains of instructions based on inter-instruction dependencies. Flow then proceeds to step S64 where the sequentially first instruction of each linear chain is dispatched to the issue circuitry. Flow then proceeds to step S68 where one or more further instructions comprised in the linear chain are retained in the offline storage circuitry. Flow then returns to step S60.

FIG. 6b schematically illustrates a sequence of steps carried out by the dispatch circuitry. The sequence of steps illustrated in FIG. 6b may be carried out in parallel to the sequence of steps described in relation to FIG. 6a. Flow begins at step S70 where it is determined if a chain trigger signal identifying a particular linear chain has been received. If, at step S70, it is determined that no chain trigger signal has been received then flow remains at step S70. If, at step S70, it is determined that a chain trigger signal has been received, then flow proceeds to step S72 where it is determined if there are any further instructions in the linear chain that is identified by the chain identifier. If, at step S72, it is determined that there are no further instructions in that linear chain then flow proceeds to step S74 where the chain identifier is released for subsequent use and flow returns to step S70. If, at step S72, it was determined that there are further instructions in the linear chain, then flow proceeds to step S76 where a sequentially first one of the one or more further instructions stored in the offline storage circuitry and comprised in the identified linear chain is dispatched to the issue circuitry before flow returns to step S70.

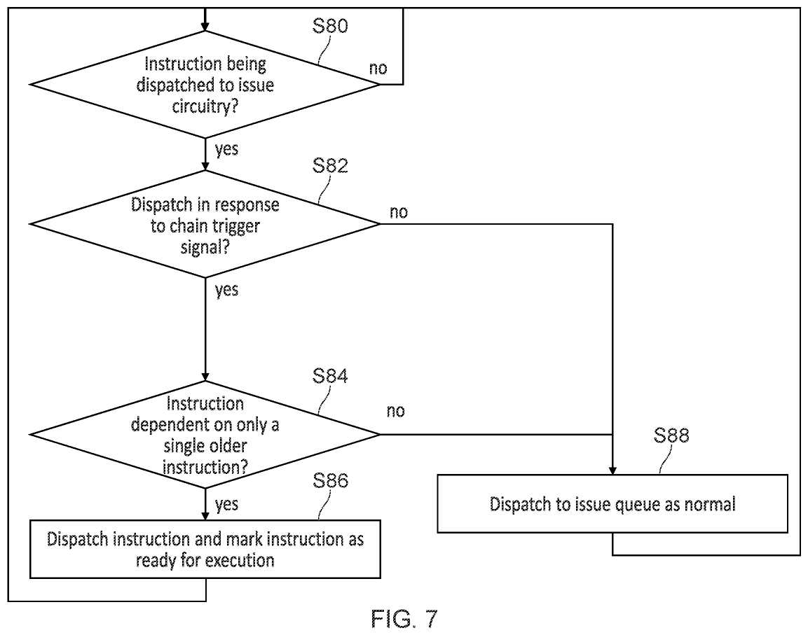

FIG. 7 schematically illustrates a sequence of instructions carried out by the dispatch circuitry when dispatching an instruction to the issue circuitry. Flow begins at step S80 where it is determined whether an instruction is being dispatched to the issue circuitry. If, at step S80, it is determined that no instructions are being dispatched to the issue circuitry, then flow remains at step S80. If, at step S80, it is determined that an instruction is being dispatched to the issue circuitry, then flow proceeds to step S82, where it is determined whether the instruction is being dispatched in response to a chain trigger signal. If, at step S82, it is determined that the dispatch is not in response to a chain trigger signal, then flow proceeds to step S88 where the instruction is dispatched to the issue queue as normal before flow returns to step S80. If, at step S82, it is determined that the instruction is being dispatched in response to a chain trigger signal, then flow proceeds to step S84 where it is determined whether the instruction is dependent on only a single older instruction. If, at step S84, it is determined that the instruction is not dependent on a single older instruction then flow proceeds to step S88 where the instruction is dispatched to the issue queue as normal before flow returns to step S80. If, at step S84, it is determined that the instruction is dependent on only a single older instruction then flow proceeds to step S86 where the instruction is dispatched and marked as ready for execution before flow returns to step S80.

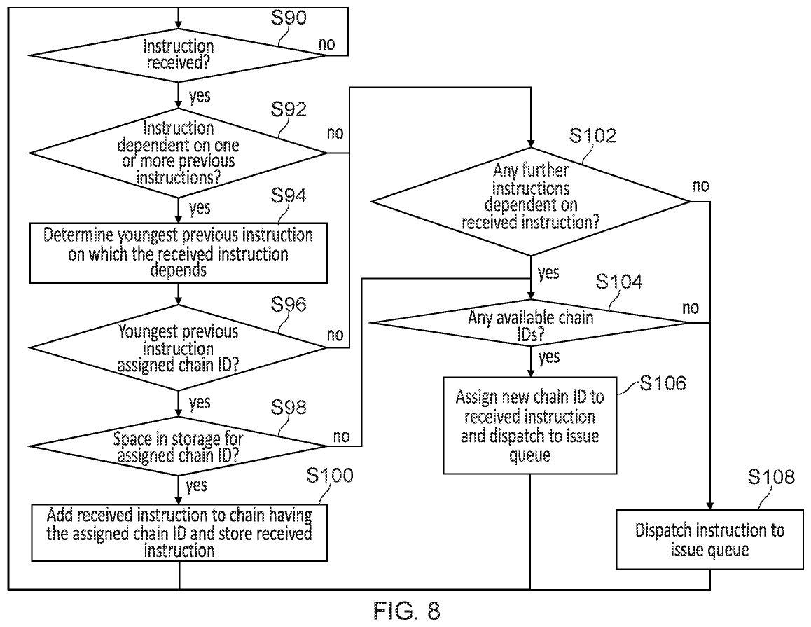

FIG. 8 schematically illustrates a sequence of steps performed by dispatch circuitry in response to receipt of an instruction according to some configurations of the present techniques. Flow begins at step S90 where it is determined if an instruction has been received. If, at step S90, it is determined that an instruction has not been received, then flow remains at step S90. If, at step S90, it is determined that an instruction has been received then flow proceeds to step S92 where it is determined if the instruction is dependent on one or more previous instructions. If, at step S92, it is determined that the instruction is dependent on one or more previous instructions, then flow proceeds to step S94 where it is determined which instruction is the youngest previous instruction on which the received instruction depends. Flow then proceeds to step S96 where it is determined if the youngest previous instruction has been assigned a chain identifier. If, at step S96, it is determined that the youngest previous instruction has been assigned a chain identifier then flow proceeds to step S98 where it is determined if there is space in the offline storage circuitry to store the instruction in association with the assigned chain identifier. If, at step S98, it is determined that there is space in the offline storage circuitry to store the instruction, then flow proceeds to step S100 where the received instruction is added to the linear chain having the assigned chain identifier and is stored in the offline storage circuitry before flow returns to step S90.

If, at step S92, it was determined that the instruction was not dependent on one or more previous instructions then flow proceeds to step S102. Similarly, if at step S96, it was determined that the youngest previous instruction was not assigned a chain identifier, then flow proceeds to step S102. At step S102 it is determined whether there are any further instructions that are dependent on the received instruction. If, at step S102, it is determined that there are no further instructions that are dependent on the received instruction, then flow proceeds to step S108 where the instruction is dispatched to the issue queue without being assigned to a linear chain before flow returns to step S90. If, at step S102, it was determined that there are further instructions that are dependent on the received instruction, then flow proceeds to step S104. Similarly, if at step S98, it was determined that there was not space to store the received instruction in association with the assigned chain identifier, then flow proceeds to step S104. At step S104, it is determined whether there are any chain identifiers available that have not been assigned to an active linear chain of instructions. If, at step S104, it is determined that there are not any chain identifiers available, then flow proceeds to step S108 where the instruction is dispatched to the issue queue without being assigned a chain identifier before flow returns to step S90. If, at step S104, it was determined that there are available chain identifiers then flow proceeds to step S106 where a new chain identifier is assigned to the received instruction and the instruction is dispatched to the issue queue before flow returns to step S90.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

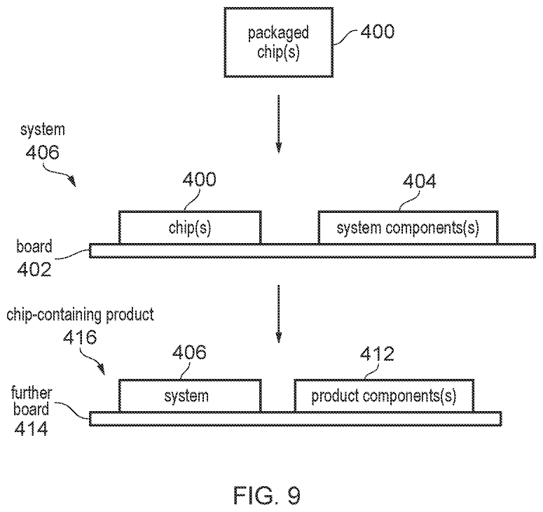

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary apparatuses, methods, systems, chip containing products, and computer readable media are disclosed. An apparatus comprises dispatch circuitry to receive instructions, and to identify linear chains of instructions each comprising a first instruction and one or more further instructions, which are temporarily ineligible for execution due to a dependence on an immediately preceding instruction. The apparatus further comprises offline storage circuitry. The dispatch circuitry is configured, for each of the linear chains: to dispatch the sequentially first instruction to the issue circuitry and to retain the one or more further instructions in the offline storage circuitry until a chain trigger signal is received, the chain trigger signal indicating that a previously dispatched instruction, on which a sequentially next instruction depends, has satisfied a predefined issuing condition. In response to receipt of the chain trigger signal, the dispatch circuitry is configured to dispatch the sequentially next instruction to the issue circuitry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are set out in the following numbered clauses:

Clause 1. An apparatus comprising:
dispatch circuitry configured to receive a sequence of decoded instructions for dispatch to issue circuitry as dispatched instructions, and to identify linear chains of instructions from the sequence of decoded instructions based on inter-instruction dependencies between the sequence of decoded instructions, wherein each one of the linear chains comprises a sequentially first instruction and one or more further instructions, each of the one or more further instructions being temporarily ineligible for execution due to a dependence on an immediately preceding one of the sequence of instructions comprised in that one of the linear chains; and
offline storage circuitry configured to store the one or more further instructions comprised in a plurality of the linear chains,
wherein the dispatch circuitry is configured, for each linear chain of the linear chains:
to dispatch the sequentially first instruction of the linear chain to the issue circuitry;
to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, to dispatch the sequentially next one of the of the one or more further instructions comprised in the linear chain to the issue circuitry.

Clause 2. The apparatus of clause 1, wherein the issue circuitry is responsive to receipt of a dispatched instruction:
in response to a determination that one or more operands associated with the dispatched instruction are indicated as ready, to mark the dispatched instruction as ready for execution; and
in response to a determination that the one or more operands associated with the dispatched instruction are not indicated as ready, to store the dispatched instruction in an issue queue.

Clause 3. The apparatus of clause 2, wherein the issue circuitry is responsive to broadcast information indicating readiness of an operand:
to store an indication of readiness of the operand in an operand availability table;
to determine, for each dispatched instruction stored in the issue queue and not marked as ready for execution, whether the operand corresponds to the one or more operands associated with that dispatched instruction; and
when the operand corresponds to one of the one or more operands associated with that dispatched instruction, to tag that dispatched instruction with information indicating the availability of the operand.

Clause 4. The apparatus of clause 3, wherein the issue circuitry is responsive to a determination that each of the one or more operands associated with one of the dispatched instructions is indicated as available, to mark that dispatched instruction as ready for execution.

Clause 5. The apparatus of clause 3 or clause 4, wherein the issue circuitry is configured, when determining whether to mark dispatched instructions as ready for execution, to:
consider the dispatched instructions stored in the issue queue; and
defer considering the one or more further instructions retained in the offline storage circuitry until those instructions are dispatched to the issue queue.

Clause 6. The apparatus of any preceding clause, wherein the predefined issuing condition is satisfied when a dispatched instruction comprised in the linear chain is issued for execution.

Clause 7. The apparatus of any preceding clause, wherein for at least a predefined type of dispatched instruction, the predefined issuing condition is considered to be speculatively satisfied when the predefined type of dispatched instruction is marked as ready for execution.

Clause 8. The apparatus of clause 7, wherein the predefined type of dispatched instruction is a single cycle latency instruction.

Clause 9. The apparatus of any of clauses 2 to 8, wherein the dispatch circuitry is configured to, when the sequentially next further instruction is dispatched and when the sequentially next further instruction is dependent only on the previously dispatched instruction, mark the sequentially next further instruction as ready for execution.

Clause 10. The apparatus of any preceding clause, wherein the offline storage circuitry is responsive to a flush request, to discard the one or more further instructions comprised in each of the linear chains.

Clause 11. The apparatus of any preceding clause, wherein:
the dispatch circuitry is configured to identify instructions belonging to each linear chain of instructions by assigning a chain identifier from a pool of chain identifiers to those instructions; and
the dispatch circuitry is configured, for each decoded instruction of the sequence of decoded instructions:
to determine whether the decoded instruction is dependent on one or more active linear chains of instructions; and
when the decoded instruction is dependent on one or more active linear chains, to assign, to the decoded instruction, the chain identifier assigned to one of the one or more active linear chains on which the decoded instruction depends.

Clause 12. The apparatus of clause 11, wherein the dispatch circuitry is configured, when the decoded instruction is dependent on one or more active linear chains, to select the chain identifier assigned to a youngest one of the one or more active linear chains on which the decoded instruction depends.

Clause 13. The apparatus of clause 11 or clause 12, wherein the dispatch circuitry is configured, when the decoded instruction is not dependent on any active linear chains and when at least one further decoded instruction is dependent on the decoded instruction, to perform a chain identifier assignment procedure comprising:
when the pool of chain identifiers comprises an unassigned chain identifier, assigning the unassigned chain identifier to the decoded instruction; and
when the pool of chain identifiers comprises no unassigned chain identifiers, to dispatch the decoded instruction to the issue circuitry without assigning a chain identifier.

Clause 14. The apparatus of any of clauses 11 to 13, wherein the dispatch circuitry is configured, when the decoded instruction is not dependent on any active linear chains and when at no further decoded instructions are identified as being dependent on the decoded instruction, to dispatch the decoded instruction to the issue circuitry without assigning a chain identifier.

Clause 15. The apparatus of any of clauses 1 to 14, wherein the dispatch circuitry is configured to store the one or more further instructions of each linear chain as a linked list within the offline storage circuitry.

Clause 16. The apparatus of any of clauses 1 to 14, wherein the offline storage circuitry is arranged as a plurality of discrete queues and the dispatch circuitry is configured to store the one or more further instructions of each linear chain in one of the discrete queues.

Clause 17. The apparatus of clause 16, wherein the dispatch circuitry is responsive to a determination that retaining one or more further instructions of one or the linear chains in the offline storage circuitry would cause a capacity of one of the plurality of discrete queues to be exceeded, to split that linear chain into a plurality of linear chains.

Clause 18. A system comprising:
the apparatus of any preceding clause, implemented in at least one packaged chip;
at least one system component; and
a board,
wherein the at least one packaged chip and the at least one system component are assembled on the board.

Clause 19. A chip-containing product comprising the system of clause 17 assembled on a further board with at least one other product component.

Clause 20. A non-transitory computer-readable medium to store computer-readable code for fabrication of the apparatus according to any preceding clause.

Clause 21. A method comprising:
receiving a sequence of decoded instructions for dispatch to issue circuitry as dispatched instructions;
identifying linear chains of instructions from the sequence of decoded instructions based on inter-instruction dependencies between the sequence of decoded instructions, each one of the linear chains comprising a sequentially first instruction and one or more further instructions, each of the one or more further instructions being temporarily ineligible for execution due to a dependence on an immediately preceding one of the sequence of instructions comprised in that one of the linear chains;
for each linear chain of the linear chains:
dispatching the sequentially first instruction of the linear chain to the issue circuitry;
retaining the one or more further instructions of the given linear chain in offline storage circuitry configured to store the one or more further instructions comprised in a plurality of the linear chains until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, dispatching the sequentially next one of the of the one or more further instructions comprised in the linear chain to the issue circuitry.

We claim:

1. An apparatus comprising:
dispatch circuitry configured to receive a sequence of decoded instructions for dispatch to issue circuitry as dispatched instructions, and to identify linear chains of instructions from the sequence of decoded instructions based on inter-instruction dependencies between the sequence of decoded instructions, wherein each one of the linear chains comprises a sequentially first instruction and one or more further instructions, each of the one or more further instructions being temporarily ineligible for execution due to a dependence on an immediately preceding one of the sequence of instructions comprised in that one of the linear chains; and
offline storage circuitry configured to store the one or more further instructions comprised in a plurality of the linear chains,
wherein the dispatch circuitry is configured, for each linear chain of the linear chains:
to dispatch the sequentially first instruction of the linear chain to the issue circuitry;
to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, to dispatch the sequentially next one of the of the one or more further instructions comprised in the linear chain to the issue circuitry.

2. The apparatus of claim 1, wherein the issue circuitry is responsive to receipt of a dispatched instruction:
in response to a determination that one or more operands associated with the dispatched instruction are indicated as ready, to mark the dispatched instruction as ready for execution; and
in response to a determination that the one or more operands associated with the dispatched instruction are not indicated as ready, to store the dispatched instruction in an issue queue.

3. The apparatus of claim 2, wherein the issue circuitry is responsive to broadcast information indicating readiness of an operand:
to store an indication of readiness of the operand in an operand availability table;
to determine, for each dispatched instruction stored in the issue queue and not marked as ready for execution, whether the operand corresponds to the one or more operands associated with that dispatched instruction; and
when the operand corresponds to one of the one or more operands associated with that dispatched instruction, to tag that dispatched instruction with information indicating the availability of the operand.

4. The apparatus of claim 3, wherein the issue circuitry is responsive to a determination that each of the one or more operands associated with one of the dispatched instructions is indicated as available, to mark that dispatched instruction as ready for execution.

5. The apparatus of claim 3, wherein the issue circuitry is configured, when determining whether to mark dispatched instructions as ready for execution, to:
consider the dispatched instructions stored in the issue queue; and
defer considering the one or more further instructions retained in the offline storage circuitry until those instructions are dispatched to the issue queue.

6. The apparatus of claim 1, wherein the predefined issuing condition is satisfied when a dispatched instruction comprised in the linear chain is issued for execution.

7. The apparatus of claim 1, wherein for at least a predefined type of dispatched instruction, the predefined issuing condition is considered to be speculatively satisfied when the predefined type of dispatched instruction is marked as ready for execution.

8. The apparatus of claim 2, wherein the dispatch circuitry is configured to, when the sequentially next further instruction is dispatched and when the sequentially next further instruction is dependent only on the previously dispatched instruction, mark the sequentially next further instruction as ready for execution.

9. The apparatus of claim 1, wherein the offline storage circuitry is responsive to a flush request, to discard the one or more further instructions comprised in each of the linear chains.

10. The apparatus of claim 1, wherein:
the dispatch circuitry is configured to identify instructions belonging to each linear chain of instructions by assigning a chain identifier from a pool of chain identifiers to those instructions; and
the dispatch circuitry is configured, for each decoded instruction of the sequence of decoded instructions:
to determine whether the decoded instruction is dependent on one or more active linear chains of instructions; and
when the decoded instruction is dependent on one or more active linear chains, to assign, to the decoded instruction, the chain identifier assigned to one of the one or more active linear chains on which the decoded instruction depends.

11. The apparatus of claim 10, wherein the dispatch circuitry is configured, when the decoded instruction is dependent on one or more active linear chains, to select the chain identifier assigned to a youngest one of the one or more active linear chains on which the decoded instruction depends.

12. The apparatus of claim 10, wherein the dispatch circuitry is configured, when the decoded instruction is not dependent on any active linear chains and when at least one further decoded instruction is dependent on the decoded instruction, to perform a chain identifier assignment procedure comprising:
when the pool of chain identifiers comprises an unassigned chain identifier, assigning the unassigned chain identifier to the decoded instruction; and
when the pool of chain identifiers comprises no unassigned chain identifiers, to dispatch the decoded instruction to the issue circuitry without assigning a chain identifier.

13. The apparatus of claim 10, wherein the dispatch circuitry is configured, when the decoded instruction is not dependent on any active linear chains and when at no further decoded instructions are identified as being dependent on the decoded instruction, to dispatch the decoded instruction to the issue circuitry without assigning a chain identifier.

14. The apparatus of claim 1, wherein the dispatch circuitry is configured to store the one or more further instructions of each linear chain as a linked list within the offline storage circuitry.

15. The apparatus of claim 1, wherein the offline storage circuitry is arranged as a plurality of discrete queues and the dispatch circuitry is configured to store the one or more further instructions of each linear chain in one of the discrete queues.

16. The apparatus of claim 15, wherein the dispatch circuitry is responsive to a determination that retaining one or more further instructions of one or the linear chains in the offline storage circuitry would cause a capacity of one of the plurality of discrete queues to be exceeded, to split that linear chain into a plurality of linear chains.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A non-transitory computer-readable medium to store computer-readable code for fabrication of an apparatus comprising:
dispatch circuitry configured to receive a sequence of decoded instructions for dispatch to issue circuitry as dispatched instructions, and to identify linear chains of instructions from the sequence of decoded instructions based on inter-instruction dependencies between the sequence of decoded instructions, each one of the linear chains comprising a sequentially first instruction and one or more further instructions, each of the one or more further instructions being temporarily ineligible for execution due to a dependence on an immediately preceding one of the sequence of instructions comprised in that one of the linear chains; and
offline storage circuitry configured to store the one or more further instructions comprised in a plurality of the linear chains,
wherein the dispatch circuitry is configured, for each linear chain of the linear chains:
to dispatch the sequentially first instruction of the linear chain to the issue circuitry;
to retain the one or more further instructions of the linear chain in the offline storage circuitry until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, to dispatch the sequentially next one of the of the one or more further instructions comprised in the linear chain to the issue circuitry.

20. A method comprising:
receiving a sequence of decoded instructions for dispatch to issue circuitry as dispatched instructions;
identifying linear chains of instructions from the sequence of decoded instructions based on inter-instruction dependencies between the sequence of decoded instructions, each one of the linear chains comprising a sequentially first instruction and one or more further instructions, each of the one or more further instructions being temporarily ineligible for execution due to a dependence on an immediately preceding one of the sequence of instructions comprised in that one of the linear chains;
for each linear chain of the linear chains:
dispatching the sequentially first instruction of the linear chain to the issue circuitry;
retaining the one or more further instructions of the given linear chain in offline storage circuitry configured to store the one or more further instructions comprised in a plurality of the linear chains until a chain trigger signal identifying the linear chain is received, the chain trigger signal indicating that a previously dispatched instruction, on which a sequentially next one of the one or more further instructions comprised in the linear chain depends, has satisfied a predefined issuing condition; and
in response to receipt of the chain trigger signal, dispatching the sequentially next one of the of the one or more further instructions comprised in the linear chain to the issue circuitry.
